(19) United States
(12) Patent Application Publication
(10) Pub. No.: US 2010/0291301 A1
(43) Pub. Date: Nov. 18, 2010

(54) JOINTING COMPOSITION AND METHOD

(75) Inventor: Chad Paul ATZEMIS, Geneva, OH (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: EXCEL POLYMERS LLC, Solon, OH (US)

(21) Appl. No.: 12/780,466

(22) Filed: May 14, 2010

Related U.S. Application Data
(60) Provisional application No. 61/178,832, filed on May 15, 2009.

(51) Int. Cl. C08K 5/54; C08K 5/5435; C08K 5/541; C08K 5/544; B05D 3/00

(52) U.S. Cl. 427/331; 524/264; 524/265; 524/261; 524/188

(57) ABSTRACT

Various embodiments of a jointing composition are disclosed. In one embodiment, the aggregate jointing composition includes a thermoplastic polymer, a thermoset resin, and an amphiphillic coupling agent. In another embodiment the jointing compositions herein further include aggregate material. The jointing compositions herein chemically and physically promote retention of the materials within a continuous aggregate phase, improve resilience and flexibility, and provide stain/haze free installations.

### PRIORITY CLAIM

This Utility Patent Application is claims priority to U.S. Provisional Patent Application No. 61/178,832 filed on May 15, 2009, and which is incorporated by reference herein.

### BACKGROUND

Jointing compositions are used in many applications to bind materials together. Jointing compositions that include aggregate materials, can be used a as grout, between tiles, for example. Another type of jointing composition that includes aggregate material are also known as polymer sands or organic sands which are used between paving stones in driveways, walkways, and patios. Polymer sands are composed of conventional masonry sands dry blended with a water-soluble thermoplastic, organic polymers. In many instances a polymer, such as ethylene vinyl acetate or a closely related vinyl acetate derivative, is used as the thermoplastic organic polymer. Similarly, organic sands are composed of conventional masonry sands dry blended with an organic tackifying resin.

When water is added to these jointing compositions, e.g. the polymer sand or organic sands, the thermoplastic polymer or thermoset resin is dissolved and is distributed around the aggregate material, and upon drying, forms a film. The presence of the thermoplastic polymer or thermoset resin may slow the rate of sand washout from between paving stones or bricks over for a period of time. However, depending upon the environmental conditions, for example, repeated exposure to rain and other elements, the concentration of the thermoplastic polymer and resin in the jointing sands decreases, leaving the sands to be washed out. As a result, space is created between the paving stones or bricks and the overall integrity of the system is lowered over the lifetime of its applicable use. In addition, many of these jointing compositions result in “hard” seams that can be deteriorated by normal usage.

### SUMMARY

Various embodiments of a jointing composition are provided. In one embodiment, a jointing composition includes a thermoplastic polymer, a thermoset resin, and an amphiphillic coupling agent. In another embodiment the jointing composition further includes at least one aggregate material, and therefore, the jointing composition includes a thermoplastic polymer, a thermoset resin, an amphiphillic coupling agent, and an aggregate material.

In another embodiment, the method for using a jointing composition comprises mixing components of a jointing composition comprising an aggregate material with a thermoplastic polymer, a thermoset resin, and an amphiphillic coupling agent to form a dry mix, followed by the steps of applying the dry mix to the area of application, for example between at least two surfaces, and contacting the jointing composition with a solvent, for example water, to form a continuous aggregate phase. The step of contacting the dry mix with a solvent can precede or follow the step of applying the jointing composition to an area where jointing is desired.

### BRIEF DESCRIPTION OF DRAWINGS

The accompanying drawings and photos, which are incorporated in and constitute a part of the specification, illustrate various example embodiments of aspects of the invention. Elements may not be drawn to scale.

FIG. 1 is a top view of a base layer used in the testing an aggregate jointing composition according to an embodiment of the present invention;

FIG. 2 is a top view of a mold apparatus filled with a jointing composition according to an embodiment of the present invention; and

FIG. 3 is a top view of a mold apparatus used in the testing a jointing composition according to an embodiment of the present invention.

### DETAILED DESCRIPTION

Jointing compositions and methods of making the same are disclosed. In one embodiment the jointing composition includes, a thermoplastic polymer component, a thermoset resin, and an amphiphillic coupling agent. The jointing compositions herein, when combined with aggregate materials and solvent, have been found to chemically and physically promote retention of the materials within a continuous aggregate phase, improve resilience and flexibility, and provide stain/haze free installations.

In one embodiment the jointing composition herein comprises, by weight, from about 40% to about 90% thermoplastic polymer, in another embodiment, from about 50% to about 85%, and in yet another embodiment, from about 60% to about 80% thermoplastic polymer. The amount of thermoset resin ranges, by weight, from about 20% to about 40%, in another embodiment, from about 5% to about 30%, and in yet another embodiment, from about 7% to about 28% thermoset resin. The coupling agent is present in an amount, by weight, from about 20% to about 40%, in another embodiment, from about 5% to about 30%, and in yet another embodiment from about 7% to about 28% coupling agent.

In another embodiment, the amount of thermoplastic polymer is greater than each of the thermoset resin and coupling agent materials in the jointing composition.

In one embodiment the ratio of thermoplastic polymer to thermoset resin ranges from about 2:1 to about 10:1, and in another embodiment, from about 4:1 to about 8:1. In another example, the weight of coupling agent to the total weight of thermoplastic and thermoset components ranges from about 1:5 to about 1:20.

The jointing compositions herein may have a greater amount of thermoset resin than amphiphillic coupling agent and also may have a greater amount of amphiphillic coupling agent than thermoset resin. For example, in one embodiment, the amount of thermoset resin is greater than the amount of amphiphillic coupling agent and the ratio of the thermoplastic polymer to thermoset resin to amphiphillic coupling agent is present in the jointing composition ranges from about 4:1.5:1 to about 12:2.5:1. In another amount of amphillic coupling agent is greater than the amount of thermoset resin and the ratio of thermoplastic polymer to thermoset resin to amphiphillic coupling agent ranges from about 4:0.5:2 to about 12:1.5:2.

Suitable thermoplastic polymers that may be used in the jointing composition include water dispersible thermoplastics having a hydroxyl group or an acetate moiety. Acetate moieties can be converted to hydroxyl groups, upon application of enough water to begin dissolving the polymer in an environment free of inhibiting species. In one embodiment the jointing composition includes a polymer that is a vinyl acetate, and in another embodiment, an ethylene copolymer of a vinyl acetate. An example of an ethylene copolymer includes, but is not limited to, vinyl acetate-ethylene, also commonly known as ethylene vinyl acetate (EVA). There are a variety of commercial ethylene vinyl acetates (EVA) available.

The jointing compositions herein also include a thermoset resin. In one embodiment, the thermoset resin participates in self-polymerization reactions or cross-linking reactions involving hydroxyl functional groups, or other functional groups, in the thermoplastic resin component. In one embodiment the thermoset resin of the jointing composition includes a polyfunctional amine. In another embodiment the polyfunctional amine is a melamine. More specifically, the jointing composition includes any melamine or melamine derivative. Suitable examples include, but are not limited to, diaminopropylethylenediamine, polypropylenepolyamine, polyethylenepolyamine, ammonia, methylated melamines such as hexamethoxymethyl melamine, methyl melamine, methylene melamine, methylene tetramine, butylated melamines, and isobutylated melamines.

The coupling agent of the jointing composition includes at least one amphiphillic coupling agent. The coupling agent functions to retard the elution of the thermoplastic polymer and thermoset resin components from the aggregate component of the jointing system. One example of a suitable coupling agent includes silane, SiH₄. In another embodiment, the coupling agent is an organo-silane having at least two different reactive groups. Examples of organo-silanes that have at least two different reactive groups includes, but is not limited to, vinyl silane, acryloxy silane, epoxy silane, aminosilane, mercaptosilane, chlorosilane, oxysilane, fluorosilane, and bis(triethoxysilypropyl)tetrasulfide.

When the thermoplastic polymer, the thermoset resin component, and the coupling agent are prepared and dry blended with aggregate component to form the aggregate jointing composition, the composition can be applied and installed through conventional methods familiar to those skilled in the art of paving stone and masonry installations. The aggregate jointing composition may be activated through the application of a solvent, for example water, in a manner consistent with methods known to those of skill in the art.

In another embodiment, any of the jointing compositions described above can further include at least one aggregate material. That is, a jointing composition can include a thermoplastic polymer component, a thermoset resin component, an amphiphillic coupling agent, and an aggregate material. The aggregate material is used to resist compressive stress. The composition may be dry blended and thereafter activated by the addition of a solvent, for example, water.

Therefore, in one embodiment the jointing composition herein comprises aggregate in an amount, by weight, from about 70% to about 98% aggregate, in another embodiment, from about 80% to about 95%, and in yet another embodiment, from about 93% to about 97% aggregate. The amount of thermoplastic polymer present, by weight, ranges from about 2% to about 20%, in another embodiment, from about 2% to about 15%, and in yet another embodiment, from about 3% to about 5% thermoplastic polymer. The amount of thermoset resin ranges, by weight, from about 0.25% to about 10%, in another embodiment, from about 0.5% to about 8%, and in yet another embodiment, from about 0.5% to about 2% thermoset resin. The coupling agent is present in an amount, by weight, from about 0.25% to about 10%, in another embodiment, from about 0.5% to about 8%, and in yet another embodiment from about 0.5% to about 2% coupling agent.

There are a variety of different applications in which the jointing composition can be applied which can affect the weight proportions of the aggregate, thermoplastic polymer, thermoset resin and coupling agent components. For example, in an application for grout, the amount of aggregate in the jointing composition may be less than that which is present in a jointing composition for an outdoor paving application. For example the amount, by weight, of aggregate material used in grout can range from about 70% to 98% and in another embodiment, from about 80% to about 95% aggregate material. In an application for pavers, the amount, by weight, of aggregate material used can range from about 80% to about 98%, and in another embodiment, from about 93% to about 97% aggregate material.

In many applications the weight ratio of aggregate material to the other materials present in the jointing composition is much greater than the combined weight of the other components. In one embodiment the weight ratio of aggregate material to total weight of thermoplastic, thermoset, and coupling agent, can range from about 9:1 to about 25:1, and in another embodiment from about 6:1 to about 25:1.

The amount of coupling agent present relative to the surface area of the aggregate material, can affect the ability of the jointing compound to chemically and physically promote retention of the materials that make up the jointing composition within the continuous aggregate phase. The surface area of the aggregate can vary widely and the weight ratio of aggregate material to coupling agent can range from about 50:1 to about 250:1.

As described above in embodiments of the jointing compositions described above, the ratio of the thermoplastic polymer to amphiphillic coupling agent to thermoset resin present in the jointing composition containing aggregate ranges from about 4:1.5:1 to about 12:2.5:1 or from about 4:0.5:2 to about 12:1.5:2. In another embodiment the ratio of thermoplastic polymer to thermoset resin ranges from about 2:1 to about 10:1, and in another embodiment, from about 4:1 to about 8:1.

The aggregate component of the jointing system may generally include any conventional or non-conventional aggregate, including but not limited to various grades of sand or quartz, recycled or cured/ground rubber, mineral colorants, mineral aggregates, gravel, coal bottom ash, boiler slag, or any other suitable aggregate material. It will be recognized by one of skill in the art that any other suitable aggregate material may be used.

In one embodiment, a method for making the jointing composition comprises the mixing a thermoplastic polymer, a thermoset resin, and an amphiphillic coupling agent, and optionally, an aggregate. For example, the thermoplastic polymer component, thermoset resin component, and the coupling agent are prepared and dry blended with aggregate component to form the jointing composition which can be applied and installed through conventional methods familiar to those skilled in the art of paving stone and masonry installations. Therefore, in one embodiment the method of using any of the variety of jointing compositions described herein comprises the step of mixing components of a jointing composition comprising an aggregate material, a thermoplastic polymer, thermoset resin, and an amphiphillic coupling agent to form a dry mix, and the step of applying the dry mix to the area of application, for example, between at least two surfaces where jointing is desired. These steps are then followed by contacting the jointing composition with a solvent, for example water, to form a continuous aggregate phase. In another embodiment, the method of using the jointing composition comprises the step of mixing an aggregate material with a thermoplastic polymer, a thermoset resin, and an amphiphillic coupling agent to form a dry mix, followed by the step of adding solvent, for example water, to the dry mix to make a wet jointing composition. This step is then followed by applying the wet jointing composition to an area of application, for example, between at least two surfaces where jointing is desired.

### EXAMPLES

Sample jointing compositions containing aggregate were prepared by using varying weight ratios of thermoplastic polymer, thermoset resin, and amphiphillic coupling agent. Sample jointing compositions were made by combining masonry sand, ethylene vinyl acetate polymer, hexamethoxymethyl melamine resin, and bis(triethoxysilypropyl)tetrasulfide as the coupling agent for a total weight of 100 grams per sample.

The various samples of jointing composition comprising polymer, thermoset resin, and amphiphillic coupling agent were each placed in a plastic cup with drain holes in the bottom. The jointing compositions samples contained in the cups were flushed with water and the flush water was collected to evaluate the amount of sand loss and the clouding of the flush wash due to polymer. After the samples of jointing compositions were dried, they were observed and rated for hardness and flexibility. Table 1 lists the test results of control sample 1, conventional polymer sand, and samples 2-19 of jointing compositions of varying weight ratios of ethylene vinyl acetate polymer, hexamethoxymethyl melamine resin, and bis(triethoxysilypropyl)tetrasulfide.

TABLE 1

| | | | Hexamethoxy- | | Order Flushed | Sand Loss (1-10, | Polymer Clouding | |
|---|---|---|---|---|---|---|---|---|
| | | Coupling | methyl | | (with 1 liter water/ | 1 being no sand | in Water (1 | Hardness |
| Sample | EVA | Agent | melamine | | min and collected | loss, 10 being | no clouding, 10 | (1 hardest, |
| Number | (grams) | (grams) | (grams) | Comments | in 1 L beaker) | most sand loss) | most clouding) | 13 softest) |
| Control 1 | 4 | 0 | 0 | | 1 | 8 | 8 | 1 |
| 2 | 2 | 0 | 0.5 | | 6 | 10 | 5 | 4 |
| 3 | 2 | 0 | 1.5 | sticky | Not | | | 13 |
| | | | | | tested | | | |
| 4 | 2 | 0.5 | 0 | | Not | | | 11 |
| | | | | | tested | | | |
| 5 | 2 | 0.5 | 0.5 | | 7 | 9 | 8 | 9 |
| 6 | 2 | 0.5 | 1.5 | sticky | 8 | 3 | 1 | |
| 7 | 2 | 1 | 0 | | Not | | | 12 |
| | | | | | tested | | | |
| 8 | 2 | 1 | 0.5 | sticky | 12 | 10 | 10 | 9 |
| 9 | 2 | 1 | 1.5 | | 11 | 2 | 10 | 6 |
| 10 | 4 | 0 | 0.5 | sticky | 10 | 2 | 3 | 7 |
| 11 | 4 | 0 | 1.5 | sticky | 14 | 5 | 8 | 5 |
| 12 | 4 | 0.5 | 0 | | 2 | 1 | 2 | 2 |
| 13 | 4 | 0.5 | 0.5 | | 3 | 5 | 4 | 3 |
| 14 | 4 | 0.5 | 1.5 | | 9 | 2 | 1 | 10 |
| 15 | 4 | 1 | 0 | | 4 | 7 | 10 | 4 |
| 16 | 4 | 1 | 0.5 | | 5 | 2 | 3 | 4 |
| 17 | 4 | 1 | 1.5 | sticky | 13 | 1 | 2 | 8 |
| 18 | 0 | 0 | 1.5 | | Not | | | 13 |
| | | | | | tested | | | |
| 19 | 0 | 0.5 | 1.5 | | Not | | | 13 |
| | | | | | tested | | | |

In sample 16 of Table 1, the ethylene vinyl acetate polymer, silane coupling agent, and hexamethoxymethyl melamine combined in a ratio of approximately 8:2:1, respectively, and added with 94.5 grams of sand. Additional tests, as described above for Table 1, were run with jointing compositions having the same ratio but added to jointing sand or aggregate material at a cumulative level of between 2% and 10%. The ethylene vinyl acetate polymer, hexamethoxymethyl melamine resin, and the bis(triethoxysilypropyl)tetrasulfide coupling agent were dry blended with the masonry sand.

Referring now to Table 2, the tensile strength and the elongation at break of several commercially available aggregate jointing systems were compared with the tensile strength and elongation at break values for the aggregate jointing composition of sample 16 shown in Table 1.

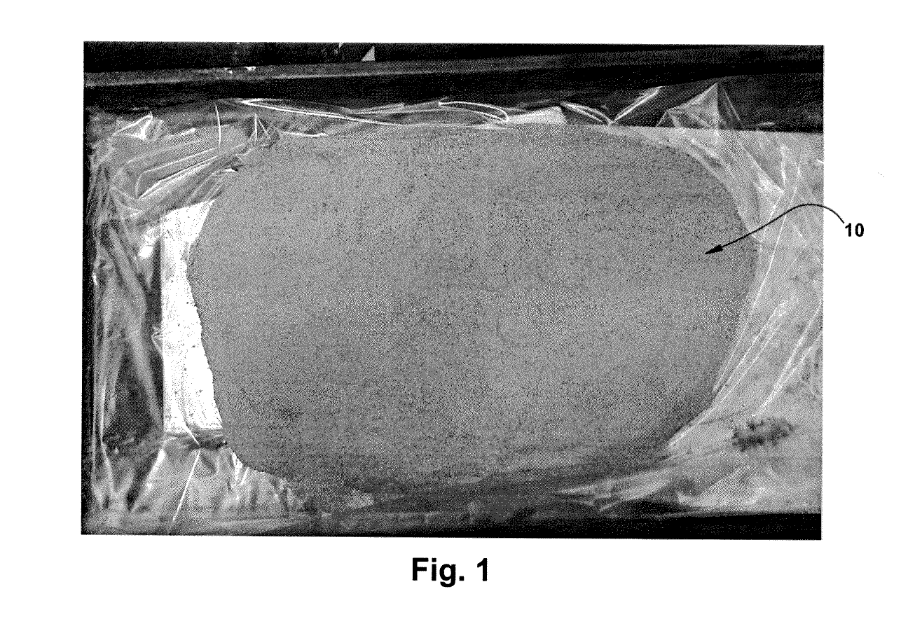

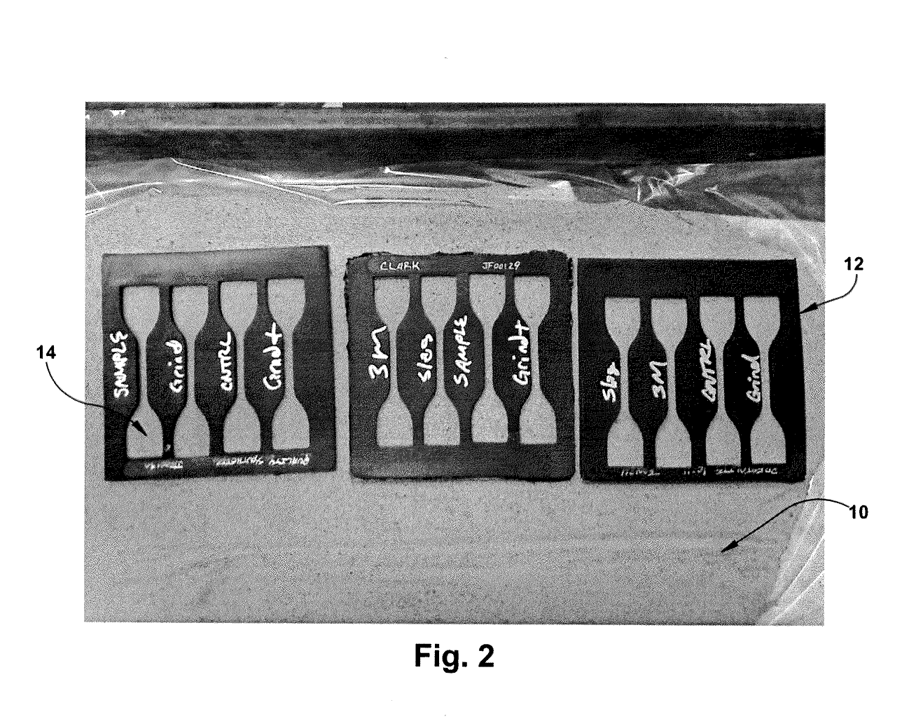

As shown in FIG. 1, a uniform 0.25 inch base layer 10 of masonry grade leveling sand was applied on a level surface. As shown in FIG. 2, a labeled template 12 comprised of one or more rubber sheets, stacked and affixed so as to minimize relative translocation, was placed on top of the base layer 10. Mold cavities 14 were created by forming non-contiguous voids in the labeled template using a cutting die.

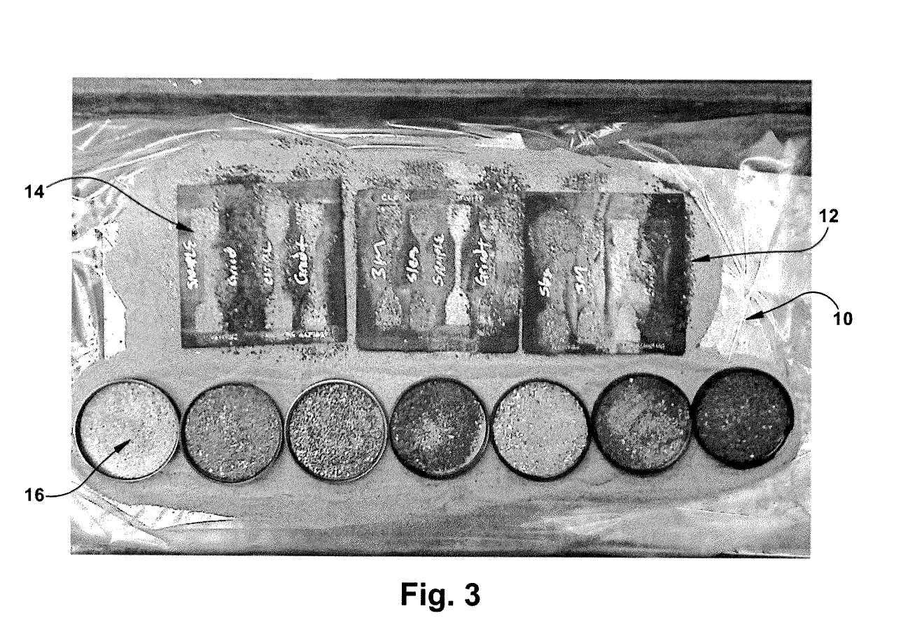

Referring now to FIG. 3, the sample composition 16 was skreeted to a uniform depth using the labeled template 12 as a guide. The samples were uniformly sprayed with water in a fine mist. The jointing composition was allowed to cure in the molds in a humidity controlled environment (70% RH) until dry and stabilized. The samples were removed from the molds and tested for tensile strength and the elongation at break in accordance with ASTM D-412-6a.

TABLE 2

| | Number of | Elongation | Tensile |
|---|---|---|---|
| | Crumbled Samples | at | Strength at |
| | (when removed | Break | Break |
| Aggregate Jointing System | from mold - max 4) | (inches) | (pounds) |
| Sand Lock Premix | 4 | | |
| Sand Edge Tan (White | 1 | 0.07 | 2 |
| Bloom) | | | |
| Snapedge 7/24 (White | 1 | 0.05 | 1.75 |
| Bloom) | | | |
| Unicare Gray | 4 | | |
| Unilock Max Tan | 2 | | |
| Supersand - Tan | 0 | 0.025 | 0.1 |
| Techniseal R6 | 4 | | |
| Joint Lock P-Paug | 2 | | |
| PCI Standard | 0 | 0.05 | 5 |
| Sample Composition 16 | 0 | 0.26 | 25 |

Comparing the sample jointing composition of sample 16 described in Example 1 to commercially available jointing systems having the same aggregate component, it was determined that and embodiment of the jointing composition disclosed herein yielded tensile strengths five to fifteen times those of the commercially available materials. The elongation at break value for the sample jointing composition herein was three to four times that of commercially available jointing systems.

Although the composition has been described with regard to certain example embodiments, it is to be understood that the present disclosure has been made by way of example only, and the improvements, changes and modifications in the details of construction and the combination and arrangement of parts is contemplated.

What is claimed is:

1. A jointing composition comprising:
a thermoplastic polymer;
a thermoset resin; and
an amphiphillic coupling agent.

2. The jointing composition of claim 1, wherein the jointing composition comprises:
from about 40% to about 90%, by weight, thermoplastic polymer;
from about 20% to about 40%, by weight, thermoset resin; and
from about 20% to about 40%, by weight, amphiphillic coupling agent.

3. The jointing composition of claim 1, wherein:
the thermoplastic polymer comprises at least one of a hydroxyl group and an acetate moiety;
the thermoset resin comprises a polyfunctional amine; and
the coupling agent comprises an organo-silane.

4. The jointing composition of claim 3, wherein the jointing composition comprises:
from about 40% to about 90%, by weight, of the at least one of a hydroxyl group and an acetate moiety;
from about 20% to about 40%, by weight, of polyfunctional amine; and
from about 20% to about 40%, by weight, organo-silane coupling agent.

5. The jointing composition of claim 1, wherein the thermoplastic polymer component is water dispersible.

6. The jointing composition of claim 1, wherein the thermoplastic resin comprises a material selected from the group of: vinyl acetate and an ethylene copolymer of vinyl acetate.

7. The jointing composition of claim 1, wherein the thermoset resin comprises melamine or melamine derivative.

8. The jointing composition of claim 1, wherein the amphiphillic coupling agent comprises organo-silane comprising at least two different reactive groups.

9. The jointing composition of claim 1, wherein:
the thermoplastic polymer comprises a material selected from the group of a vinyl acetate and an ethylene copolymer of a vinyl acetate;
the thermoplastic polymer comprises a material selected from the group of:
diaminopropylethylenediamine, polypropylenepolyamine, polyethylenepolyamine, ammonia, methylated melamines such as hexamethoxymethyl melamine, methyl melamine, methylene melamine, methylene tetramine, butylated melamines, and isobutylated melamines; and
the amphiphillic coupling agent comprises a material selected from the group of: vinyl silane, acryloxy silane, epoxy silane, aminosilane, mercaptosilane, chlorosilane, oxysilane, fluorosilane, and bis(triethoxysilypropyl)tetrasulfide.

10. The jointing composition of claim 1, wherein:
the thermoplastic polymer comprises ethylene vinyl acetate;
the thermoset resin comprises hexamethoxymethyl melamine; and
the amphiphillic coupling agent comprises bis(triethoxysilypropyl)tetrasulfide.

11. The jointing composition of claim 1, wherein the ratio of thermoplastic polymer to the thermoset resin present in the jointing mixture ranges from about 2:1 to about 10:1.

12. The jointing composition of claim 1, wherein the ratio of the thermoplastic polymer to amphiphillic coupling agent to thermoset resin present in the jointing composition ranges from about 4:1.5:1 to about 12:2.5:1 or from about 4:0.5:2 to about 12:1.5:2.

13. The jointing composition of claim 1, further comprising an aggregate material.

14. The jointing composition of claim 13, wherein the aggregate material selected from the group of: sand, silica, ground granite, natural stone, boiler slag, synthetic inorganic aggregate, iron oxide, fly ash, calcium carbonate, calcium silicate, clay.

15. The composition of claim 13, wherein the amount of aggregate ranges, by weight, from about 90% to about 97% based on the total weight of the jointing composition.

16. The jointing composition of claim 13, wherein the jointing composition comprises by weight:
from about 2% to about 20% thermoplastic polymer;
from about 0.25% to about 10% thermoset resin;
from about 0.25% to about 10%, amphiphillic coupling agent; and
from about 70% to about 98% aggregate.

17. The jointing composition of claim 13, wherein:
the thermoplastic polymer comprises at least one of a hydroxyl group and an acetate moiety;
the thermoset resin comprises a polyfunctional amine; and
the coupling agent comprises an organo-silane.

18. The jointing composition of claim 3, wherein the jointing composition comprises:
from about 40% to about 90%, by weight, of the at least one of a hydroxyl group and an acetate moiety;
from about 20% to about 40%, by weight, of polyfunctional amine; and
from about 20% to about 40%, by weight, organo-silane coupling agent.

19. The jointing composition of claim 13, wherein:
the thermoplastic polymer comprises a material selected from the group of a vinyl acetate and an ethylene copolymer of a vinyl acetate;
the thermoplastic polymer comprises a material selected from the group of:
diaminopropylethylenediamine, polypropylenepolyamine, polyethylenepolyamine, ammonia, methylated melamines such as hexamethoxymethyl melamine, methyl melamine, methylene melamine, methylene tetramine, butylated melamines, and isobutylated melamines; and
the amphiphillic coupling agent comprises a material selected from the group of: vinyl silane, acryloxy silane, epoxy silane, aminosilane, mercaptosilane, chlorosilane, oxysilane, fluorosilane, and bis(triethoxysilypropyl)tetrasulfide; and
the aggregate is selected from the group of: sand, silica, ground granite, natural stone, boiler slag, synthetic inorganic aggregate, iron oxide, fly ash, calcium carbonate, calcium silicate, clay.

20. A method of using a jointing compound comprising the steps of:
mixing components of a jointing composition comprising an aggregate material, a thermoplastic polymer, a thermoset resin, and an amphiphillic coupling agent to form a dry mix of the jointing composition;
applying the dry mix to an area of application; and
contacting the jointing composition with a solvent.
